(19) United States
(12) Patent Application Publication
(10) Pub. No.: US 2022/0353602 A1
(43) Pub. Date: Nov. 3, 2022

(54) METHOD FOR OPERATING A HEARING AID AND SYSTEM HAVING THE HEARING AID

(71) Applicant: Sivantos Pte. Ltd., Singapore (SG)

(72) Inventors: Jana Thiemt, Erlangen (DE); Stefan Petrausch, Erlangen (DE)

(21) Appl. No.: 17/866,738

(22) Filed: Jul. 18, 2022

Related U.S. Application Data
(63) Continuation of application No. PCT/EP2020/051174, filed on Jan. 17, 2020.

(51) Int. Cl. H04R 1/10; H04R 25/00

(52) U.S. Cl. CPC H04R 1/1041; H04R 25/609; H04R 25/50; H04R 2225/41; H04R 2225/55

(57) ABSTRACT

A method operates a hearing aid. At least one sensor signal is generated by at least one sensor of the hearing aid or at least one sensor of an auxiliary apparatus that can be associated with the hearing aid. At least one first piece of weather information is provided by a communications unit. A usage state of the hearing aid and/or an operating environment of the hearing aid is estimated on the basis of the first piece of weather information and on the basis of the sensor signal. The at least one operating parameter of the hearing aid is adjusted on the basis of the estimated usage state or the estimated operating environment.

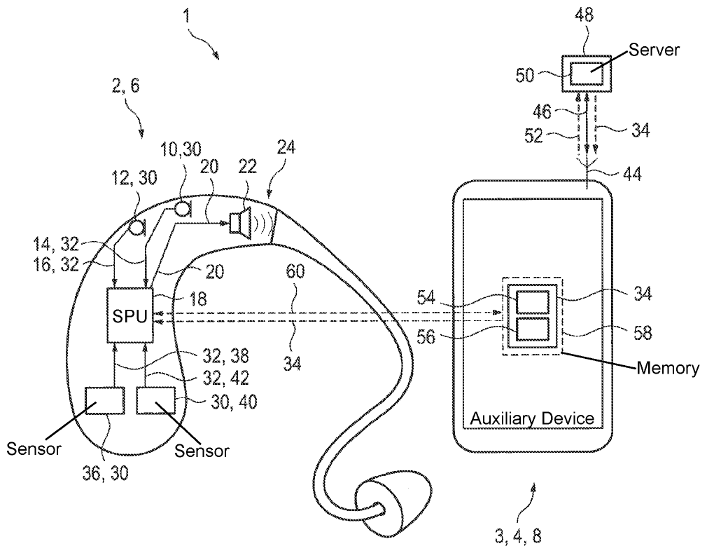

### CROSS-REFERENCE TO RELATED APPLICATION

This application is a continuation, under 35 U.S.C. § 120, of copending International Patent Application PCT/EP2020/051174, filed Jan. 17, 2020, which designated the United States; the prior application is herewith incorporated by reference in its entirety.

### FIELD AND BACKGROUND OF THE INVENTION

The invention relates to a method for operating a hearing aid. At least one sensor of the hearing aid generates at least one sensor signal. The first sensor signal is taken as a basis for gauging a state of use of the hearing aid and/or an operating environment of the hearing aid. The gauged state of use, or the gauged operating environment, is taken as a basis for setting at least one operating parameter of the hearing aid.

A hearing device is normally used to look after a hearing impairment. This involves at least one electroacoustic input transducer of the hearing device, that is to say for example a microphone, converting a sound signal from the environment into an electrical audio signal that is processed on the basis of the hearing impairment and amplified, in particular in a frequency-band-dependent manner. The user-specific signal processing performed in this way is used to generate an output signal that, by way of an electroacoustic output transducer of the hearing device, for example by way of a loudspeaker or else a bone conduction earpiece, generates a corresponding sound signal and supplies it to the ear of the user. The signal processing of the audio signal is effected not only on the basis of the individual requirements arising from the hearing impairment of the user of the hearing device, but preferably also on the basis of a typified hearing situation in the environment and if necessary on the basis of further situation-specific parameters.

A hearing situation in this case describes in particular a multiplicity of acoustic environments for which, as a result of empirical values, the useful signal sources present in said hearing situation are taken as a basis for assuming similar or comparable parameters of the signal processing to be advantageous for the user, and which differ from another hearing situation in a relevant manner by way of easily classifiable features that in turn affect the advantageous signal processing.

A specific hearing situation is normally identified directly on the basis of the audio signal itself. This may be insufficient for some hearing situations, however. As such, particularly the change from an enclosed space, in which in particular reverberation effects occur, into the open air, where other disturbing sounds such as for example traffic noise can potentially occur, may not be identifiable from the audio signal sufficiently reliably. The two aforementioned situations preferably require different processings of the audio signal (suppression of the reverberation versus noise rejection while maintaining the spatial impression), however.

Depending on the hearing situation, noise rejection in this case should preferably also be capable of distorting a spatial hearing impression as little as possible, and of prioritizing the spatial hearing impression over noise rejection in case of doubt (such as for example in road traffic). Moreover, maintaining the spatial impression may also need to be prioritized on the basis of a use situation of the hearing device, for example in the case of sport, where it is often desirable to be able to pick up sound signals from many directions if possible. Identification of the hearing situation solely from the audio signal often fails to provide satisfactory results for such requirements.

### SUMMARY OF THE INVENTION

The invention is therefore based on the object of specifying for a hearing aid a method that is able to identify an environment situation and/or a state of use of the hearing aid as easily and reliably as possible.

The aforementioned object is achieved according to the invention by a method for operating a hearing aid, wherein at least one sensor of the hearing aid and/or at least one sensor of an auxiliary apparatus associable with the hearing aid generate/s at least one sensor signal. A communication unit is used to provide at least first weather information. The first weather information and the sensor signal are taken as a basis for gauging a state of use of the hearing aid and/or an operating environment of the hearing aid. The gauged state of use, or the gauged operating environment, is taken as a basis for setting at least one operating parameter of the hearing aid. Configurations that are advantageous and in some cases inventive in themselves are the subject matter of the subclaims and the description that follows.

A hearing aid in the present case includes in particular a hearing device that is intended and equipped for looking after a hearing impairment. Furthermore, a hearing aid also includes a hearing assistance of the kind that may be used by a normally hearing person, for example a headset or, in particular smart, headphones. The communication unit is intended and equipped in particular for connection to the Internet and is preferably located in the immediate environment of the hearing aid, that is to say for example likewise on the body of the wearer of the hearing aid or for example also within reach at his workstation, for the purpose of performing the method. The communication unit is implemented in particular by appropriate functions and/or applications on a cell phone (preferably a smartphone), a tablet PC or a smartwatch.

The communication unit is preferably configured and equipped for a user input by way of which the wearer of the hearing aid is able to control additional functions of the communication unit and in particular is able to select specific weather information from a plurality of provided pieces of weather information and if necessary to highlight the specific weather information or to specially mark it in another way for the continuation of the method. The communication unit is preferably equipped for connection to the hearing aid, for example by way of Bluetooth or by way of near field communication (NFC).

A sensor of the hearing aid includes in particular any measuring device arranged in or on the hearing aid that is equipped to record a physical variable in the area of the environment of the hearing aid by means of a suitable measurement and to map the physical variable as appropriate to an electrical sensor signal generated in this way.

An auxiliary apparatus associable with the hearing aid includes in particular an apparatus that is able to be connected to the hearing aid for data interchange purposes and preferably wirelessly (e.g. by way of Bluetooth or similar protocols) and that is able to be carried by the wearer of the hearing aid and preferably worn on the body, that is to say e.g. a cell phone (in particular smartphone) or a smartwatch. A sensor of the auxiliary apparatus associable with the hearing aid therefore accordingly includes a measuring device arranged in or on the auxiliary apparatus for recording a physical variable in the environment of the auxiliary apparatus and preferably in the environment of the hearing aid. If the sensor signal is provided by at least one sensor of the auxiliary apparatus, the communication unit is preferably likewise implemented on the auxiliary apparatus. As such, for example one or more sensors of a smartphone and the communication functions thereof may be used for the method.

In particular, the sensor included in this case is a temperature sensor, the sensor signal being a temperature signal. In addition, the sensor of the hearing aid also includes in particular an electroacoustic input transducer, such as for example a microphone, or an arrangement of multiple such input transducers (for example for the purpose of directional miking), which is configured for generating an electrical audio signal from ambient sound. The sensor signal generated, or output, in this case is the corresponding audio signal.

Weather information includes in particular information in respect of a current weather condition, preferably for the current location of the hearing aid, which may include an indication in respect of an outside temperature and/or a wind speed and/or a current amount or strength of precipitation and/or an air humidity and/or an air pressure. The first weather information preferably contains at least an approximate indication of an outside temperature and/or a wind speed.

The first weather information is preferably provided by way of a connection from the communication unit to a system that is equipped for appropriately providing the first weather information, that is to say for example a cloud server of a public or private weather service or of another information service that provides weather information as part of its service. The first weather information may be retrieved in particular in an up-to-date manner each time by connecting the communication unit to the appropriate system at a desired time, or may be issued for a present time on the basis of a weather forecast retrieved from the system beforehand. The latter approach is in particular advantageous if a connection from the communication unit to the system cannot be set up sufficiently reliably over a longer period, for example several hours, and so the first weather information for a specific time may be provided on the basis of the weather prediction or forecast collected previously for this time.

An operating environment of the hearing aid includes in particular an enclosed space and an open outdoor space (that is to say operation in the open air). The operating environment may in particular also contain a further, finer division of the two aforementioned cases. A finer division of this kind may contain in particular a means of transport such as a motor car or a bus or the like as operating environment, and, in the case of an enclosed space, also a possibly graduated assessment of the size of the space (which may be relevant in particular for reverberation phenomena). Such a subdivision may moreover comprise the distinction in regard to whether the hearing device is operated during a sports activity. A state of use of the hearing aid includes in particular a use during active operation and a temporary suspension of use, possibly in conjunction with removal of the hearing aid.

An operating parameter of the hearing aid includes in particular a parameter in respect of an active operating mode or an inactive, or standby, operating mode. In particular, the term operating parameter also covers parameters of the signal processing of the hearing aid, that is to say specific values of a gain for a given frequency band, directional microphone settings, settings relating to a degree of reverberation suppression, etc. Also included are parameters that relate to the identification of a hearing situation from an audio signal, that is to say in particular time constants, limit values for a noise background, or for a voice component or the like.

The first weather information preferably relates to a description of a comparable physical and/or climatic property of the environment of the hearing aid, as is measured by the at least one sensor of the hearing aid, or of the auxiliary apparatus, or is derivable on the basis of the sensor signal. As such, the first weather information contains for example an indication of an actual or predicted temperature at the location of the hearing aid while the at least one sensor measures a temperature. In other words, that is to say that the first weather information corresponds to the measured variable measured by the at least one sensor, or to a variable, or information, derived from the sensor signal. Providing the first weather information allows comparison against the at least one sensor signal to be used to identify whether the first weather information is compatible with the sensor signal or appropriately suitable information derived therefrom in respect of a physical and/or climatic property of the environment that relates to the first weather information, and accordingly allows the state of use and/or the operating environment to be inferred.

If for example temperature information of the first weather information is substantially incompatible with a temperature measured by a temperature sensor, then operation in an enclosed space may be assumed. To compare an outside temperature from the first weather information against a temperature measured by a temperature sensor of the hearing aid, a possible influence of a body temperature of the wearer of the hearing aid is preferably taken into consideration, e.g. by way of an appropriate offset for limit values during the comparison.

The operating environment and/or the state of use of the hearing aid is thus assessed in the manner described here, the first weather information being able to be compared with the sensor signal or a variable derived therefrom in the communication unit or in the hearing aid. In the former case, the sensor signal from the at least one sensor and/or a variable derived therefrom is transmitted to the communication unit, which returns an assessed operating environment and/or an assessed state of use to the hearing aid as the result. In the second case, the communication unit transmits the first weather information to the hearing aid for comparison there. The at least one operating parameter is preferably set in the hearing aid itself, on the basis of the assessed state of use and/or the assessed operating environment.

In particular, multiple sensor signals may also be compared against corresponding indications in the first weather information in order to be able to assess the state of use and/or the operating environment particularly reliably.

A temperature sensor as the at least one sensor of the hearing aid, or of the auxiliary apparatus associable with the hearing aid, preferably determines a first temperature, and a corresponding temperature signal is output as sensor signal. In particular, the first weather information in this case contains an at least approximate indication of an outside temperature at the location of the hearing aid. The determined temperature is firstly in particular informative as regards the environment of the hearing aid, but may also be influenced by the temperature of the body of the wearer of the hearing aid. The influence of the body temperature is preferably taken into consideration, for example by way of an offset, for a comparison with corresponding temperature information of the first weather information.

Conveniently, at least one electroacoustic input transducer, in particular a microphone, also a directional microphone, which is formed from two physically separate individual microphones, as the at least one sensor of the hearing aid generates at least one audio signal as sensor signal. The at least one audio signal is taken as a basis for analyzing wind noise, and wherein the state of use of the hearing aid and/or the operating environment of the hearing aid are gauged on the basis of the first weather information and on the basis of the analyzed wind noise. The wind noise may be assessed using known methods in order to appropriately analyze the audio signal. The result obtained for the analysis in this instance may be a binary value indicating the presence or absence of wind noise, or a continuous value indicating a probability and/or a strength of wind noise and/or a signal component of wind noise in the audio signal. On the basis of wind noise, in particular comparison against first weather information in respect of a wind strength may identify whether the wearer of the hearing aid is in the open air, if wind noise identified on the basis of the audio signal is compatible with a strong wind that is present according to the first weather information. Conversely, wind noise in the audio signal without any wind based on the weather may infer physical activity by the wearer.

Advantageously, a position determination is additionally carried out for the hearing aid in order to provide the first weather information, preferably by way of the communication unit on the basis of the assumption or identification of direct proximity to the hearing aid. In the first place, the position determination may be carried out as a standard procedure when or for the purpose of requesting the first weather information; it may be advantageous to refrain from position determination in particular if same is temporarily impossible on account of technical problems or poor reception. The position determination allows the first weather information to be matched with the location of the hearing aid. An alternative possibility is determining the first weather information for a location stipulated without position determination, e.g. on the basis of a “default” preset by the wearer for specific times of day.

Expediently, a motion sensor of the hearing aid and/or a motion sensor of the auxiliary apparatus associable with the hearing aid is/are used to identify movement by a wearer of the hearing aid. The identified movement is used for assessing the state of use of the hearing aid and/or the operating environment of the hearing aid. A motion sensor includes in particular any sensor suitable and appropriately equipped for identifying movement, e.g. an acceleration sensor and/or a gyroscope. To sense movement by the wearer of the hearing aid, the motion sensor is preferably arranged in or on the hearing device or on a smartwatch as an auxiliary apparatus.

Sensing movement by the wearer of the hearing aid may additionally help to classify a physical and/or climatic condition reproduced by the sensor signal and a concordance or variance of the first weather information. As such, for example an identified movement may be taken as a basis for associating a relatively high temperature or wind noise with a sports activity if there is no correspondence of the outside temperature or the wind (first weather information). In this case, for example a directional effect can be attenuated as an operating parameter in the signal processing of the hearing aid in order to promote more spatial hearing for the sports activity.

In one advantageous configuration, the first weather information is provided by means of a connection, in particular an Internet connection, from the communication unit to a weather server equipped for outputting weather information. By way of example, the weather server implements an independent web service of a public or private weather service provider or other information service provider (such as e.g. a news web page). In particular, the first weather information is output in a standardized format in this case.

Conveniently, the communication unit is used to provide a time-resolved weather forecast, wherein a current time is ascertained, and wherein the first weather information is provided on the basis of the time-resolved weather forecast and the current time. The time-resolved weather forecast allows the first weather information to be provided even if the communication unit is unable to retrieve current weather information for a specific time, for example because an appropriate connection is not possible.

It is found to be convenient if the state of use is gauged in respect of wearing the hearing aid on the body and/or in respect of using the hearing aid during a sports activity, and/or the operating environment is gauged in respect of operating the hearing aid in the open air or in an enclosed space. The aforementioned states of use and operating environments can be particularly advantageously assessed by means of the first weather information. Assessment of wearing the hearing aid on the body also includes in particular assessing the alternative state in this regard, that is to say removing the hearing aid for a break in operation.

Advantageously, the state of use and/or the operating environment of the hearing aid is assessed on the basis of a comparison of the first temperature and the analyzed wind noise with the corresponding first weather information for the position determined for the hearing aid in due consideration of identified movement by the wearer of the hearing aid. This permits further information to be additionally taken into consideration. Movement by the wearer of the hearing aid may in particular affect the measured temperature and wind noise ascertained by the hearing aid, which is why the identification of such movement can be used to take it into consideration in an appropriate manner, e.g. in the form of a correction for the sensor signal or the like.

Preferably, the temperature sensor of the hearing aid, or of the auxiliary apparatus associable with the hearing aid, determines a second temperature, and the first temperature and the second temperature are taken as a basis for detecting a temperature change. The first weather information and the detected temperature change are taken as a basis for assessing a change in the state of use and/or a change in the operating environment of the hearing aid. A comparison of a detected temperature change with the first weather information provides particularly reliable information about a change in the operating environment and/or in the state of use, since it allows in particular offset effects, as may arise as a result of the body temperature of the wearer and may possibly not be correctly compensated for completely, to be eliminated for the temperature change by calculating the difference between the two temperatures.

Conveniently, a change in the analyzed wind noise, in particular when the wearer is sensed to be in a state of rest without significant physical activity, is taken as a basis for assessing a change in the operating environment of the hearing aid. If wind noise changes without the wearer moving to a significant degree, this may indicate that he has left or entered an enclosed space if this conclusion is compatible with wind data of the first weather information.

Expediently, a signal processing parameter of an audio signal of the hearing aid is set as the at least one operating parameter of the hearing aid. A signal processing parameter includes in particular the following parameters: a broadband or frequency-dependent gain factor, a broadband or frequency-band-dependent compression ratio, a time constant of a compression, of an identification of a hearing situation, of an adaptive filter, of a reverberation suppression, of an identification of a noise background, of an identification of a voice activity, a directivity index. The aforementioned parameters are of particular importance for signal processing on the basis of a hearing situation.

Expediently, an assessed change in the operating environment is taken as a basis for reducing at least one time constant of a signal processing. A change in the operating environment, that is to say for example a change from an enclosed space to the open air, often requires adjustment of a plurality of parameters of the signal processing, for which purpose applicable algorithms for adjustment preferably need to be operated with reduced time constants for fast convergence in order to be able to provide the wearer with satisfactory sound from the new environment as quickly as possible.

The invention further cites a system, containing a hearing aid, at least one sensor for generating a sensor signal, and further containing a communication unit equipped for providing first weather information. The system is equipped for carrying out the method described above. The method according to the invention shares the advantages of the system. The advantages specified for the method and for its developments may be transferred mutatis mutandis to the system. The at least one sensor is preferably arranged on or in the hearing device or on or in an auxiliary apparatus associable with the hearing device. The communication unit is preferably implemented on the auxiliary apparatus.

Preferably, the communication unit is implemented on a cell phone and/or a smartwatch and/or a tablet PC.

Other features which are considered as characteristic for the invention are set forth in the appended claims.

Although the invention is illustrated and described herein as embodied in a method for operating a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURE

The FIGURE of the drawing shows a system having a hearing device and a cell phone for setting parameters of the signal processing of the hearing device on the basis of weather information provided by way of the cell phone according to the invention.

### DETAILED DESCRIPTION OF THE INVENTION

Referring now to the FIGURE of the drawing in detail, there is shown schematically a system 1 containing a hearing aid 2 and an auxiliary apparatus 3 having a communication unit 4. In the present case, the hearing aid 2 is in the form of a hearing device 6 that is intended and equipped to be worn on the ear of a wearer (not shown) for operation. In the system 1 shown in the FIGURE, the communication unit 4 is implemented on a cell phone 8 (a smartphone) as the auxiliary apparatus 3, an implementation on a tablet PC or a smartwatch likewise being possible. The hearing device 6 is intended and equipped for looking after a hearing impairment of its wearer and, for this purpose, has a first electroacoustic input transducer 10 and a second electroacoustic input transducer 12, which each convert ambient sound into a corresponding first, or second, audio signal 14, 16, and in the present case are each provided by a microphone. A configuration of the hearing device 6 with only one electroacoustic input transducer and only one corresponding audio signal is likewise possible.

The first audio signal 14 and the second audio signal 16 are supplied to a signal processing unit 18 in which an output signal 20 is generated on the basis of the first audio signal 14 and the second audio signal 16 by way of an appropriate signal processing, in particular in due consideration of the hearing impairment of the wearer of the hearing device 6. The output signal 20 is converted by an electroacoustic output transducer 22, provided in the present case by a loudspeaker, into an output sound signal 24 that is supplied to the ear of the wearer (not shown) during operation.

In order to be able to achieve as advantageous a signal processing as possible (and for example to be able to reject disturbing sounds as effectively as possible) for a hearing situation, that is to say for a specific environment of the wearer with its applicable useful signal sources and disturbing sounds, appropriate identification of such a hearing situation on the basis of the first audio signal 14 and the second audio signal 16 normally takes place in the signal processing unit 18. On the basis of the identified hearing situation, parameters for the signal processing taking place in the signal processing unit 18 are then set in order to generate the output signal 20. Identifying the hearing situation merely on the basis of the two audio signals 14, 16 does not lead to completely satisfactory results in some cases, however. By way of example, reverberation, as often occurs in enclosed spaces, in particular with bare walls, is not easy to identify when there is a noise background, which may come from disturbing sound sources. Additionally, even if a hearing situation is identified correctly per se, the case may arise in which the settings of the signal processing that are chosen therefor are not ideal for other reasons, for example in the case of a sports activity by the wearer of the hearing device 6, where improved spatial hearing is often more important than the best possible directional noise rejection.

For better performance in such situations, the system 1 has provision, as is yet to be described, for using weather information that can be taken as a basis for setting parameters of the signal processing. To put it in simple terms, a sensor 30 arranged in the hearing device 6 is used to measure a physical, or climatic, variable of the environment, and a sensor signal 32 generated in the process or a variable or information derived therefrom is compared with first weather information 34 provided by the communication unit 4. The or a further sensor 30 may also be arranged in the auxiliary apparatus 3 (not shown). This comparison and possibly further information may now be taken as a basis for assessing in particular whether the wearer of the hearing device 6 is in an enclosed space or in the open air, whether he is wearing the hearing device 6 on his ear for operation, or has removed it for a break in operation, or whether he is engaged in sports activity (while the hearing device 6 is being operated).

The sensor 30 arranged in the hearing device 6 for this purpose is first a temperature sensor 36, which generates, as sensor signal 32, a temperature signal 38 that is supplied to the signal processing unit 18. In this arrangement, the signal processing unit 18 is equipped for processing the two audio signals 14, 16 to produce the output signal 20 on the basis of the sensor signal 32 and the first weather information 34, in particular by way of one or more processor units, one or more main memory modules, at least one nonvolatile memory for storing operationally relevant functions and presets, etc. In the present case, the sensors 30 also include the first electroacoustic input transducer 10 and the second electroacoustic input transducer 12, which means that the first and second audio signals 14, 16 are used as sensor signals 32 for comparison against the first weather information 34 in the signal processing unit 18. For this purpose, the first and second input signals 14, 16 may be taken as a basis for identifying wind noise in the immediate environment of the hearing device 6.

A further sensor 30 arranged in the hearing device 6 is moreover a motion sensor, which is in the form of an acceleration sensor 40 in the present case and which is equipped for sensing movement by the wearer of the hearing device 6 and outputs a corresponding movement signal 42 to the signal processing unit 18 as sensor signal 32. A possible alternative to the acceleration sensor 40 may in particular also be provided by a gyroscope or another sensor suitable for sensing movement. The movement signal 42 may contain information in respect of a three-dimensional movement in this case, or may merely reproduce the absolute value of a recorded acceleration, or movement. In particular if the communication unit 4 is implemented on a smartwatch as auxiliary apparatus, the motion sensor may also be arranged on the smartwatch, since the latter is worn by the wearer largely constantly on his body, just like the hearing device, which means that a corresponding movement signal 42 is sufficiently informative.

The cell phone 8 now uses an antenna 44 to make an Internet connection 46 that is used to connect the cell phone 8 to a server 48. In the present case, the server 48 is in the form of a weather server on which a weather information service 50 is implemented. The cell phone 8 now uses the Internet connection 46 to send a request 52 to the server 48, which request may in particular contain a current position of the cell phone 8. The position may have been captured by the cell phone 8 itself, for example by means of GPS. The weather information service 50 is used to transmit the first weather information 34 for the current position of the cell phone 8 to same by way of the Internet connections 46, and said information is buffer-stored in the cell phone 8. The first weather information 34 includes in particular current temperature information 54 and also current wind information 56. Further information, for example relating to the air humidity and/or relating to the current amount of precipitation and/or relating to the current air pressure at the location of the cell phone 8, may likewise be included in the first weather information 34.

The first weather information 34 is transmitted from the memory 58 of the cell phone 8 to the hearing device 6, for example by way of a Bluetooth connection 60, preferably as promptly as possible. The first weather information 34 is now compared in the signal processing unit 18 with the sensor signals 32, that is to say the temperature signal 38 and the movement signal 42, and the information relating to wind noise that is obtained from the first and second audio signals 14, 16, and this is taken as a basis for inferring an operating environment and/or a state of use of the hearing device 6, and also for setting an operating parameter of the hearing device 6 as appropriate.

The following scenarios may arise, inter alia:

The temperature sensor 36 records a drop in temperature while the acceleration sensor 40 detects physical activity by the wearer. The current time is provided as January 1, and Erlangen in Germany is detected as a current position. According to the temperature information 54 of the first weather information 34, the outside temperature is −2° C., for example. This leads to the assumption that the wearer has left an enclosed space and has gone into the open air (new operating environment: open space). The signal processing can now be adjusted for use of the hearing device 6 in the open air, for example by temporarily lowering in particular time constants of adaptive algorithms, in order to attain convergence for changed settings of the hearing device 6 as quickly as possible and accordingly to reduce the transition time for the wearer if possible.

The temperature sensor 36 records a drop in temperature while the acceleration sensor 40 detects no significant physical activity by the wearer. For the identical time and location to under 1., an outside temperature of −2° C. is again provided in the first weather information 34. This leads to the assumption that the wearer has removed the hearing device 6, and accordingly operation with all of the operating functions is no longer required. Accordingly, the hearing device 6 may be put into an inactive operating mode or standby mode.

The temperature sensor 36 records a rise in temperature while the acceleration sensor 40 records physical activity by the wearer. The time is January 1 and the current position of the system 1 is detected by way of the communication unit 4 as Singapore. Accordingly, the temperature information 54 of the first weather information 34 states that there is an outside temperature of 28° C. This leads to the assumption that the wearer of the hearing device 6 has gone from an enclosed space into the open air.

The temperature sensor 36 records a rise in temperature while the acceleration sensor 40 records significant physical activity by the wearer of the hearing device 6. The current time is e.g. May 20, and Erlangen in Germany is detected as the current position of the system 1. According to the temperature information 54, the outside temperature is 20° C., for example. This leads to the assumption that the wearer of the hearing device 6 is currently engaged in sports activity, which means that the signal processing of the hearing device can be adjusted in an appropriate manner (for example by reducing the directionality of noise rejection by means of directional microphones).

These are only some illustrative scenarios for how the aforementioned information may be used to infer an operating environment and/or a state of use of the hearing device 6.

In particular, comparison of the wind information 56 in the first weather information 34 against information relating to wind noise, as may be obtained from the first audio signal 14 and the second audio signal 16, additionally allows operation of the hearing device 6 in the open air to be inferred (if there is concordance for the presence of wind), or allows sports activity to be inferred (if there is wind noise that should not occur according to the wind information 56, in particular in conjunction with physical activity recorded by the acceleration sensor 40).

Although the invention has been illustrated and described more thoroughly in detail by way of the preferred exemplary embodiment, the invention is not restricted by this exemplary embodiment. Other variations may be derived therefrom by a person skilled in the art without departing from the scope of protection of the invention.

The following is a summary list of reference numerals and the corresponding structure used in the above description of the invention:
1 system
2 hearing aid
3 auxiliary apparatus
4 communication unit
6 hearing device
8 cell phone
10 first electroacoustic input transducer
12 second electroacoustic input transducer
14 first audio signal
16 second audio signal
18 signal processing unit
20 output signal
22 electroacoustic output transducer
24 output sound signal
30 sensor
32 sensor signal
34 first weather information
36 temperature sensor
38 temperature signal
40 acceleration sensor
42 movement signal
44 antenna
46 Internet connection
48 server
50 weather information service
52 request
54 temperature information
56 wind information
58 memory
60 Bluetooth connection

1. A method for operating a hearing aid, which comprises the steps of:
generating, via at least one sensor of the hearing aid and/or at least one sensor of an auxiliary apparatus associable with the hearing aid, at least one sensor signal;
using a communication unit to provide first weather information;
taking the first weather information and the at least one sensor signal as a basis for gauging a state of use of the hearing aid and/or an operating environment of the hearing aid; and
taking a gauged state of use, or a gauged operating environment as a basis for setting at least one operating parameter of the hearing aid.

2. The method according to claim 1, wherein the at least one sensor of the hearing aid or of the auxiliary apparatus associable with the hearing aid is a temperature sensor, the method further comprises:
determining a first temperature; and
outputting a corresponding temperature signal as the at least one sensor signal.

3. The method according to claim 2, which further comprises:
generating, via the at least one sensor of the hearing aid, at least one audio signal as the at least one sensor signal, wherein the at least one sensor is at least one electroacoustic input transducer, and the at least one audio signal is taken as a basis for analyzing wind noise; and
gauging the state of use of the hearing aid and/or the operating environment of the hearing aid on a basis of the first weather information and on a basis of the wind noise analyzed.

4. The method according to claim 3, which further comprises carrying out a position determination for the hearing aid in order to provide the first weather information.

5. The method according to claim 2, which further comprises:
using a motion sensor of the hearing aid and/or a motion sensor of the auxiliary apparatus associable with the hearing aid to identify movement by a wearer of the hearing aid; and
using identified movement for assessing the state of use of the hearing aid and/or the operating environment of the hearing aid.

6. The method according to claim 1, wherein the first weather information is provided by means of a connection from the communication unit to a weather server equipped for outputting weather information.

7. The method according to claim 1, which further comprises:
using the communication unit to provide a time-resolved weather forecast;
ascertaining a current time; and
providing the first weather information on a basis of the time-resolved weather forecast and the current time.

8. The method according to claim 4, wherein:
the state of use is gauged in respect of wearing the hearing aid on a body and/or in respect of using the hearing aid during a sports activity; and/or
the operating environment is gauged in respect of operating the hearing aid in open air or in an enclosed space.

9. The method according to claim 8, wherein the state of use and/or the operating environment of the hearing aid is assessed on a basis of a comparison of the first temperature and the wind noise with the first weather information for the position determined for the hearing aid in due consideration of identified movement by a wearer of the hearing aid.

10. The method according to claim 2, which further comprises:
determining, via the temperature sensor of the hearing aid or of the auxiliary apparatus associable with the hearing aid, a second temperature, and the first temperature and the second temperature are taken as a basis for detecting a temperature change; and
taking the first weather information and the temperature change as a basis for assessing a change in the state of use and/or a change in the operating environment of the hearing aid.

11. The method according to claim 3, which further comprises taking a change in the wind noise as a basis for assessing a change in the operating environment of the hearing aid.

12. The method according to claim 1, wherein a signal processing parameter of an audio signal of the hearing aid is set as the at least one operating parameter of the hearing aid.

13. The method according to claim 12, wherein an assessed change in the operating environment is taken as a basis for reducing at least one time constant of signal processing.

14. A system, comprising:
a hearing aid;
at least one sensor for generating a sensor signal; and
a communication unit equipped for providing first weather information, wherein the system is equipped for carrying out the method according to claim 1.

15. The system according to claim 14, wherein said communication unit is implemented on a cell phone and/or a smartwatch and/or a tablet PC.
